(19) United States
(12) Patent Application Publication
(10) Pub. No.: US 2026/0021434 A1
(43) Pub. Date: Jan. 22, 2026

(54) FILTER UNIT AND PAINT MIST REMOVAL DEVICE

(71) Applicant: Taikisha Ltd., Tokyo (JP)

(72) Inventors: Satoshi HORISAWA, Tokyo (JP); Tomotaka MIWA, Tokyo (JP); Masayuki GOTO, Tokyo (JP); Yoshikazu HAYASHI, Tokyo (JP); Hiroshi IWAKIRI, Tokyo (JP)

(21) Appl. No.: 19/271,558

(22) Filed: Jul. 16, 2025

(30) Foreign Application Priority Data
Jul. 16, 2024 (JP) 2024-113595

(51) Int. Cl. B01D 45/16; B01D 45/08; B05B 16/60

(52) U.S. Cl. CPC B01D 45/16; B01D 45/08; B05B 16/60

(57) ABSTRACT

A paint mist removal device including a filter unit configured from a metal or resin. The filter unit includes an inflow port for inflow of air containing a paint mist, a flow path that lets the air that has inflowed from the inflow port flow through and that changes a direction of flow of the air at plural locations, and an outflow port for outflow of the air that has passed through the flow path.

### CROSS-REFERENCE TO RELATED APPLICATION

This application is based on and claims priority under 35 USC 119 from Japanese Patent Application No. 2024-113595 filed on Jul. 16, 2024, the disclosure of which is incorporated by reference herein.

### BACKGROUND

### Technical Field

The present disclosure relates to a filter unit and a paint mist removal device.

### Related Art

A paint mist removal device is disclosed in Japanese Patent Application Laid-Open (JP-A) No. 2021-133269. In this paint mist removal device, a filter unit is housed in a filter case, and a paint mist can be recovered by this filter unit.

However, in the above prior art, the filter unit is configured by corrugated box paper, the filter unit to which the paint mist has adhered is burnt, and a new filter unit is placed in the filter case, with this not being desirable from the perspective of being able to reuse the filter unit.

Specifically, when a filter unit is configured from corrugated box paper or the like, part of the filter unit comes away with the paint when paint adhered to the filter unit is being removed, making it difficult to reuse the filter unit.

### SUMMARY

In consideration of the circumstances described above, an object of the present disclosure is to provide a filter unit and a paint mist removal device in which a filter unit to which paint has adhered is reusable.

A filter unit according to one aspect of the present disclosure is made of metal or resin, and includes an inflow port for inflow of air containing a paint mist, a flow path through which the air that has flowed in from the inflow port flows, and that changes a direction of flow of the air at plural locations, and an outflow port for outflow of the air that has passed through the flow path.

The present aspect includes the filter unit, and the air containing paint mist flows in from the inflow port of the filter unit. The air that has flowed in from the inflow port flows out from the outflow port via the flow path where the direction of flow of the air is changed at plural locations. This means that in the present aspect, the paint mist contained in the air can be adhered to the inside of the flow path, enabling air to be caused to flow out from the outflow port in a state in which the paint mist has been removed.

In the present aspect, the filter unit is configured from a metal or a resin, enabling damage to the filter unit when removing paint adhered to the inside of the flow path to be suppressed compared to cases in which the filter unit is configured from a corrugated box paper or the like.

As described above, the filter unit according to the present disclosure exhibits the excellent advantageous effect of enabling reuse of a filter unit to which paint has adhered.

### BRIEF DESCRIPTION OF THE DRAWINGS

Exemplary embodiments of the present invention will be described in detail based on the following figures, wherein:

FIG. 1 is a sketch diagram illustrating an outline configuration of a painting facility according to the present exemplary embodiment;

FIG. 2 is a cross-section schematically illustrating a configuration inside a painting booth according to the present exemplary embodiment;

FIG. 3 is a partial cross-section schematically illustrating a configuration of a paint mist removal device according to the present exemplary embodiment;

FIG. 4 is a horizontal cross-section schematically illustrating a configuration of filter units configuring part of a paint mist removal device according to the present exemplary embodiment (in a cross-section corresponding to a cross-section sectioned along line 4-4 of FIG. 3);

FIG. 5 is a flow speed distribution diagram of when air containing a paint mist flows inside a filter unit according to the present exemplary embodiment;

FIG. 6 is an exploded perspective view schematically illustrating a configuration of filter units according to the present exemplary embodiment;

FIG. 7 is a horizontal cross-section schematically illustrating an arrangement of components configuring filter units according to a first modified example of the present exemplary embodiment;

FIG. 8 is a horizontal cross-section schematically illustrating a configuration of a filter unit according to a second modified example of the present exemplary embodiment;

FIG. 9 is a horizontal cross-section schematically illustrating a configuration of a filter unit according to a third modified example of the present exemplary embodiment; and

FIG. 10 is a horizontal cross-section schematically illustrating a configuration of a filter unit according to a fourth modified example of the present exemplary embodiment.

### DETAILED DESCRIPTION

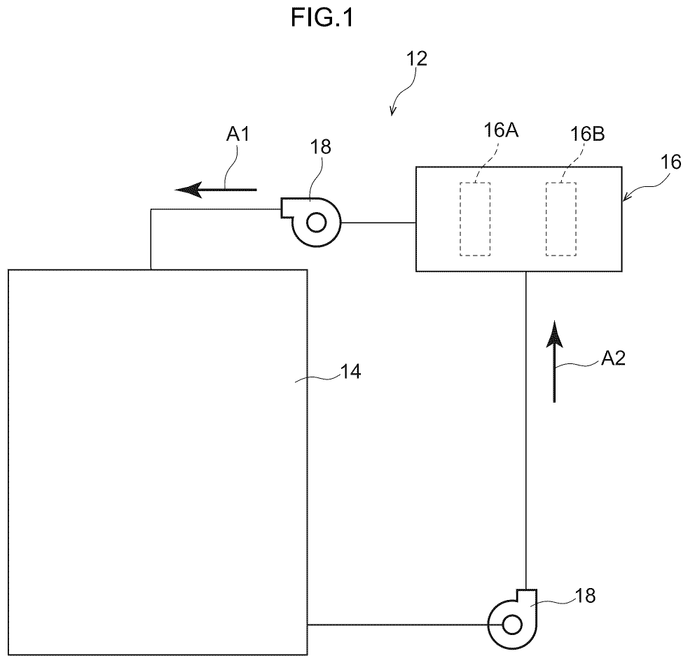

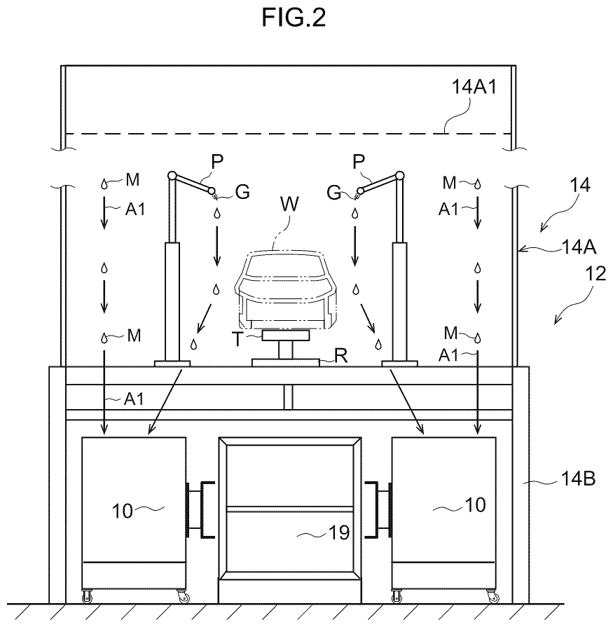

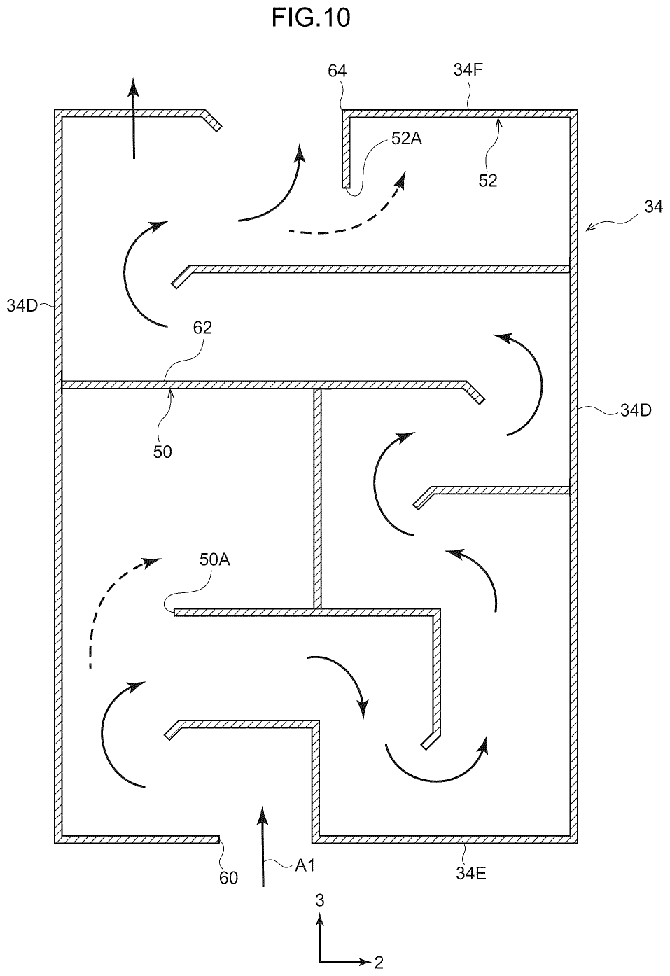

Description follows regarding a paint mist removal device 10 according to the present exemplary embodiment and a painting facility 12 equipped therewith, with reference to FIG. 1 to FIG. 10. As illustrated in FIG. 1 and FIG. 2, the painting facility 12 includes a painting booth 14, a heat pump air conditioner 16, and plural blowers (fans) 18.

The painting booth 14 includes an upper housing section 14A where a workpiece W such as a vehicle body or the like is housed, and a lower housing section 14B that is positioned at the lower side of the upper housing section 14A where the paint mist removal devices 10 and the like are housed.

More specifically, transport rails R, a transport bogie T capable of supporting a workpiece W while being able to move along the transport rails R, and painting robots P arranged at each width direction side of the transport rails R, are provided inside the upper housing section 14A.

The inside of the upper housing section 14A is configured such that a paint mist M sprayed from painting guns G provided at arm distal ends of the painting robots Pis blown against the workpiece W to form a coating film on surfaces of the workpiece W.

The air conditioner 16 includes a heating unit 16A capable of generating a hot airflow, and a cooling unit 16B capable of generating a cold airflow, and air conditioned by the air conditioner 16 is configured so as to be supplied by the blowers 18 arranged for the upper housing section 14A to inside the upper housing section 14A from the ceiling side of the upper housing section 14A.

A ceiling wall portion 14A1 is arranged in an upper portion of the upper housing section 14A, with the ceiling wall portion 14A1 being configured by a mesh structure. Thereby, air A1 compressed by the blower 18 passes through the ceiling wall portion 14A1 and flows downstream inside the upper housing section 14A, and so any paint mist M that has not adhered to the workpiece W is guided to a lower side of the upper housing section 14A.

The air A1 containing the paint mist M that has not adhered to the workpiece W is configured so as to pass through a non-illustrated grating laid out on the floor face of the upper housing section 14A and enter inside the lower housing section 14B.

The air A1 that has entered the lower housing section 14B as described above becomes air A2 when the paint mist M has been removed by the paint mist removal devices 10, in a configuration such that the air A2 is discharged outside the painting booth 14 through a discharge duct 19 coupled to the paint mist removal devices 10. Note that the air A2 is configured so as to inflow into the air conditioner 16 by the blowers 18 arranged for the lower housing section 14B.

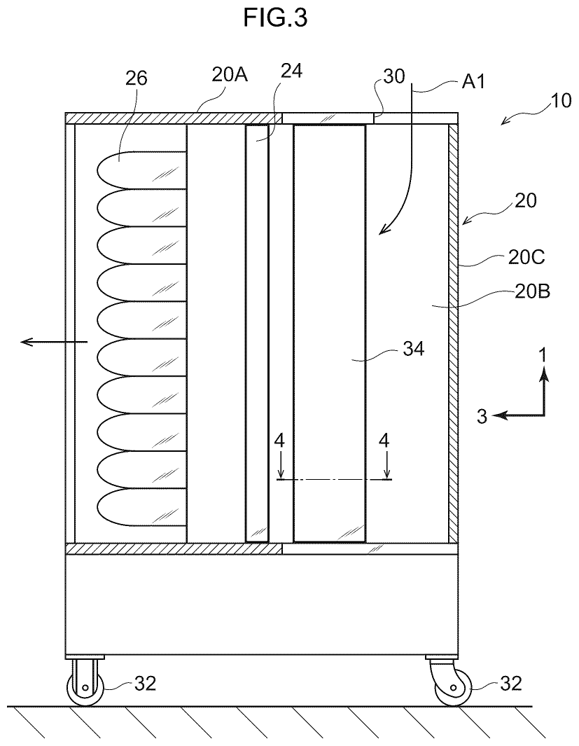

Next, description follows regarding a configuration of the paint mist removal device 10. As illustrated in FIG. 3, the paint mist removal device 10 includes a case section 20 configuring an external shell of the paint mist removal device 10, and a filter unit 34, a kraft filter 24, and a bag filter 26 that are arranged at the inside of the case section 20.

Note that a direction of arrow 1, direction of arrow 2, and a direction of arrow 3 as indicated across the drawings each indicate directions of the paint mist removal device 10. More specifically, in the present exemplary embodiment, as an example, the direction indicated by arrow 1 is defined as being the height direction of the paint mist removal device 10. Any one direction from out of the direction indicated by arrow 1, the direction indicated by arrow 2, and the direction indicated by arrow 3 is orthogonal to the other two directions. Note that in the following, unless explicitly stated otherwise, the direction indicated by arrow 1 is called a first direction, the direction indicated by arrow 2 is called a second direction, and the direction indicated by arrow 3 is called a third direction. Note that the present exemplary embodiment will, as an example, continue to be described under assumption that the first direction is aligned with the vertical direction.

The case section 20 has an external profile that is a cuboidal shape with a long direction along the first direction, and is configured including an upper wall 20A configuring part of a first direction one side (upper side) thereof, a pair of side walls 20B configuring part of a second direction one side and a second direction other side thereof, and a front wall 20C configuring part of a third direction one side (front side).

Moreover, a through-pass portion 30 is formed to a third direction one side portion of the upper wall 20A so as to pass through the upper wall 20A in the first direction. Note that the case section 20 is in a state open on the third direction other side (rear side). Moreover, plural casters 32 are attached to portions on the first direction other side (lower side) of the case section 20.

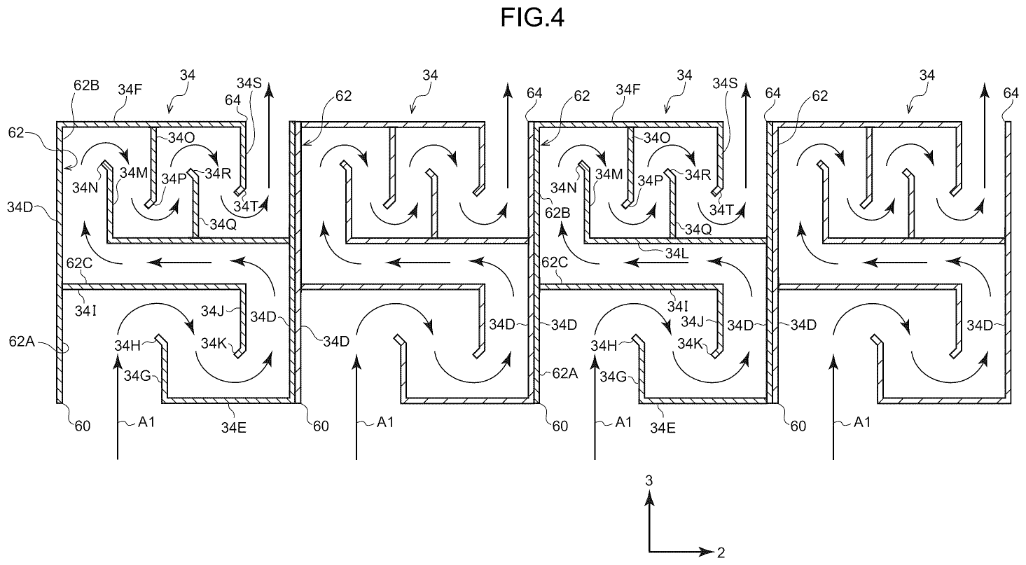

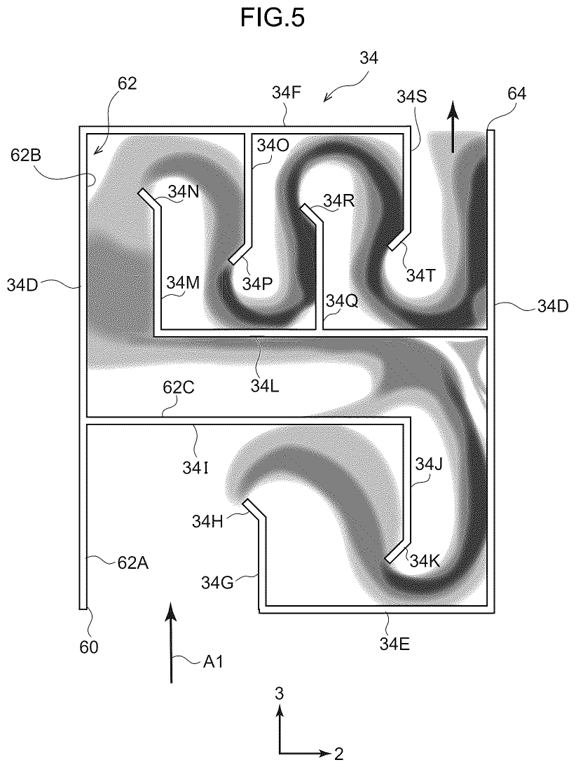

The filter unit 34 has an external profile configured with an angular tube shape extending in the first direction, and is configured from a metal such as an aluminum alloy or the like being extrusion molded (see FIG. 5). Moreover, as illustrated in FIG. 4, there are plural (in this example four) of the filter units 34 arranged along the second direction inside the case section 20.

The filter units 34 are, as illustrated in FIG. 5, each configured including an inflow port 60 through which the air A1 inflows in the third direction when open at the third direction one side, a flow path 62 that lets the air A1 that has flowed in from the inflow port 60 flow through and that changes the direction of the flow of the air A1 at plural locations, and an outflow port 64 that lets the air A1 that has passed through the flow path 62 flow out to the third direction other side.

More specifically, the filter unit 34 is configured including a pair of wall portions 34D, a wall portion 34E, and a wall portion 34F configuring an outer peripheral side of the filter unit 34, and a wall portion 34G, an extension wall portion 34H, a wall portion 34I, a wall portion 34J, an extension wall portion 34K, a wall portion 34L, a wall portion 34M, an extension wall portion 34N, a wall portion 34O, an extension wall portion 34P, a wall portion 34Q, an extension wall portion 34R, a wall portion 34S, and an extension wall portion 34T configuring an inner peripheral side of the filter unit 34.

The wall portions 34D are arranged at the second direction one side (width direction one side) and the second direction other side (width direction other side) of the filter unit 34, and extend along the third direction with a plate thickness direction in the second direction. The second direction one side wall portion 34D is positioned on the second direction one side of the inflow port 60, and the second direction other side wall portion 34D is positioned on the second direction other side of the outflow port 64.

The wall portion 34E is extended from the second direction other side of the inflow port 60 with a plate thickness direction in the third direction, and reaches the second direction other side wall portion 34D.

The wall portion 34F is extended from a peripheral edge on the third direction other side of the second direction one side wall portion 34D toward the second direction other side with a plate thickness direction in the third direction, and reaches the outflow port 64.

The wall portion 34G extends from the second direction other side of the inflow port 60 toward the third direction other side with a plate thickness direction in the second direction, and the extension wall portion 34H extends from a peripheral edge portion on the third direction other side of the wall portion 34G toward the second direction one side and the third direction other side.

The wall portion 34I extends toward the second direction other side with a plate thickness direction in the third direction from a location at about 40% of the total length of the wall portion 34D away from a third direction one side end portion of the second direction one side wall portion 34D. The wall portion 34J is extended toward the third direction one side with a plate thickness direction in the second direction from a peripheral edge portion on the second direction other side of the wall portion 34I, and the extension wall portion 34K is extended toward the second direction one side and the third direction one side from a peripheral edge portion on the third direction one side of the wall portion 34J.

The wall portion 34L is positioned at the third direction other side of the wall portion 34I and is extended toward the second direction one side with a plate thickness direction in the third direction from the second direction other side wall portion 34D. The wall portion 34M is extended toward the third direction other side with the plate thickness direction in the second direction from a peripheral edge portion on the second direction one side of the wall portion 34L, and the extension wall portion 34N is extended toward the second direction one side and the third direction other side from a peripheral edge portion on the third direction other side of the wall portion 34M.

The wall portion 34O is positioned on the second direction other side of the wall portion 34M and is extended toward the third direction one side with a plate thickness direction in the second direction from the wall portion 34F, and the extension wall portion 34P is extended toward the second direction one side and the third direction one side from a peripheral edge portion on the third direction one side of the wall portion 34O.

The wall portion 34Q is positioned on the second direction other side of the wall portion 34O, and is also extended toward the third direction other side with a plate thickness direction in the second direction from the wall portion 34L, and the extension wall portion 34R is extended from a peripheral edge portion on the third direction other side of the wall portion 34Q toward the second direction one side and the third direction other side.

The wall portion 34S is extended toward the third direction one side with a plate thickness direction in the second direction from a second direction one side of the outflow port 64, and is also positioned in the second direction between the wall portion 34Q and the second direction other side wall portion 34D. The extension wall portion 34T is extended toward the second direction one side and the third direction one side from a peripheral edge portion on the third direction one side of the wall portion 34S.

Note that in the following, portions on the third direction one side of the second direction one side and other side wall portions 34D, portions on the inflow port 60 side of the flow path 62 configured including the wall portion 34E, the wall portion 34G, the extension wall portion 34H, the wall portion 34I, the wall portion 34J, and the extension wall portion 34K, namely portions on the upstream side of the flow path 62, are referred so as an inflow side flow path 62A.

Moreover, in the following, portions on the third direction other side of the second direction one side and other side wall portions 34D, and portions on the outflow port 64 side of the flow path 62 configured including the wall portion 34F, the wall portion 34L, the wall portion 34M, the extension wall portion 34N, the wall portion 34O, the extension wall portion 34P, the wall portion 34Q, the extension wall portion 34R, the wall portion 34S, and the extension wall portion 34T, namely, portions on the downstream side of the flow path 62, are referred so as an outflow side flow path 62B.

Furthermore, in the following, in the second direction, the outlet on the second direction other side of the inflow side flow path 62A and the inlet on the second direction one side of the outflow side flow path 62B, are connected together by a connection flow path 62C extending in the second direction configured including the wall portion 34I and the wall portion 34L.

In the flow path 62 configured as described above, the wall portion 34E, the wall portion 34F, the wall portion 34I, and the wall portion 34L function as first deflection wall portions that bear the flow of the air A1 and change the direction of flow of the air A1. Moreover, the second direction other side wall portion 34D, the wall portion 34J, the wall portion 34O, the wall portion 34Q, and the wall portion 34S function as second deflection wall portions that bear the flow of the air A1 flowing along the wall portions functioning as the first deflection wall portions as described above and changes the direction of the flow of the air A1.

Namely, in the flow path 62, or more specifically in the inflow side flow path 62A and the outflow side flow path 62B, a combination of the respective wall portions functioning as the first deflection wall portions and the wall portions functioning as the second deflection wall portions are arranged in series along the flow path of the air A1.

Moreover, wall portions functioning as the second deflection wall portions are arranged in the flow path 62 at locations where the flow path 62 is bent, namely at locations where a direction of flow of the air A1 inside the flow path 62 is changed. The extension wall portion 34K, the extension wall portion 34P, the extension wall portion 34R, and the extension wall portion 34T are provided extended toward a center line side of the flow path 62 at each of these respective wall portions on the opposite side to the wall portions functioning as the first deflection wall portions.

Moreover, in the flow path 62, a mean value of cross-sectional area of a cross-section as viewed along the direction of flow of the air A1 in the outflow side flow path 62B is smaller than a mean value of cross-sectional area thereof in the inflow side flow path 62A.

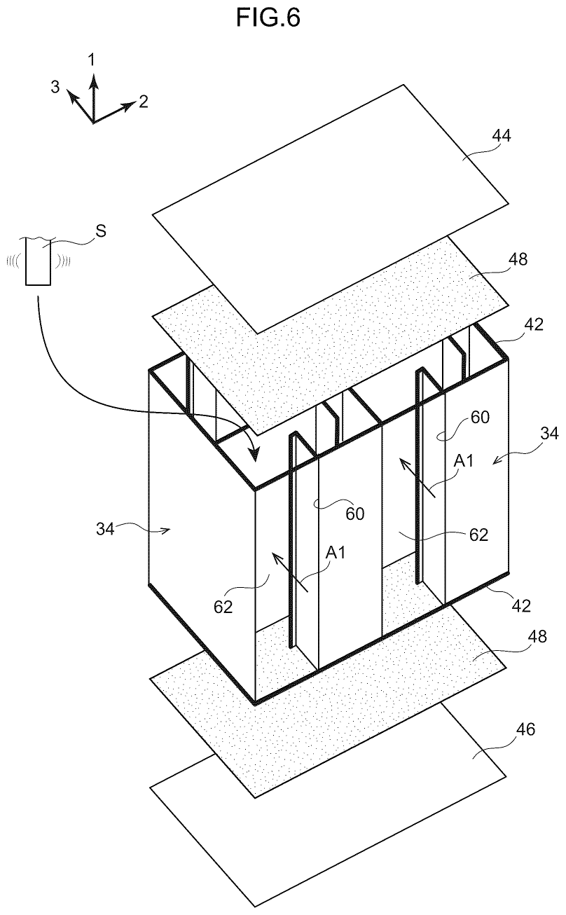

In addition thereto, the flow path 62 is provided so as to pass through the filter unit 34 in the first direction, as illustrated in FIG. 6.

The plural filter units 34 configured as described above are, as illustrated in FIG. 6, each in a state respectively connected together at both the first direction one side and the first direction other side by a frame 42 configured from angle material.

Moreover, a portion on a first direction one side of the filter unit 34 is closed off by an upper lid 44 serving as a lid capable of sliding movement in the third direction with respect to the filter unit 34, and a portion on a first direction other side of the filter unit 34 is closed off by a lower lid 46 serving as a lid capable of sliding movement in the third direction with respect to the filter unit 34.

A sheet material 48 configured from paper or the like is interposed respectively between the filter unit 34 and the upper lid 44, and between the filter unit 34 and the lower lid 46.

Note that as illustrated in FIG. 3, the kraft filter 24 and the bag filter 26 are arranged on the flow path of the air A1 in this sequence at the downstream side of the filter unit 34, enabling any of the paint mist M that had not been removed by the kraft filter 24 to be recovered.

### Operation and Advantageous Effects of Present Exemplary Embodiment

Next the operation and advantageous effects of the present exemplary embodiment will be described.

The paint mist removal device 10 according to the present exemplary embodiment includes the filter units 34 as illustrated in FIG. 3 and FIG. 4, and the air A1 containing the paint mist M inflows through the inflow ports 60 of the filter units 34. The air A1 that has inflowed from the inflow ports 60 then, as illustrated in FIG. 5, outflows from the outflow port 64 via the flow path 62 where the direction of flow of the air A1 is changed at plural locations. This means that the paint mist M contained in the air A1 is caused to adhere to the inside of the flow path 62 in the present exemplary embodiment, enabling the air A1 to be outflowed from the outflow port 64 in a state in which the paint mist M has been removed therefrom.

More specifically, the paint mist M of comparatively large droplet size is adhered to each of the inside wall portions configuring the inflow side flow path 62A, and the paint mist M of comparative small droplet size is adhered to each of the inside wall portions configuring the outflow side flow path 62B.

However, as a comparative example, when the filter units are configured by corrugated box paper or the like, if an attempt is made to remove paint adhered to the filter units, then part of the filter units comes away with the paint, making it difficult to reuse the filter units. Specifically, when the filter units are configured from corrugated box paper or the like, the filter units to which the paint has adhered are discarded and burnt.

However, in the present exemplary embodiment, the filter units 34 are configured from a metal, and in contrast to the above comparative example, damage to the filter units 34 when removing the paint adhered to the inside of the flow path 62 can be suppressed compared to cases in which the filter units 34 are configured by corrugated box paper or the like.

Moreover, in the present exemplary embodiment, the flow path 62 is provided with plural sets of the first deflection wall portions that bear the flow of the air A1 and change the direction of flow of the air A1, and the second deflection wall portions that are extended from the first deflection wall portions and that bear the flow of the air A1 flowing along the first deflection wall portions and change the direction of flow of the air A1.

As an example, in the flow path 62, a pair of the wall portion 34I and the wall portion 34J and a pair of the wall portion 34E and the wall portion 34D are arranged in series.

This means that in the present exemplary embodiment, the flow of the air A1 in the vicinity of a portion of the wall portion 34J on the opposite side to the wall portion 34I is accelerated due to being turned, and the paint mist M can be centrifugally separated from the air A1 and adhered to the inside of the flow path 62. Specifically, the centrifugally separated paint mist M is adhered to a portion of the wall portion 34J on the opposite side to the wall portion 34I and to the extension wall portion 34K.

However, consideration is given to resistance to the flow of the air A1 becoming large when the air A1 that has been accelerated in this manner collides as is with the wall portion 34D, and to a resultant increase in pressure loss when the air A1 passes through the flow path 62.

Thus in the present exemplary embodiment, for example, the extension wall portion 34K is provided extended toward the center line side of the flow path 62 at the third direction one side of the wall portion 34J. This means that although there is a drop in speed of the flow of the air A1 due to the resistance of the extension wall portion 34K, the resistance due to this flow colliding with the wall portion 34D can be made smaller by a smaller velocity vector toward the wall portion 34D side of this flow. As a result thereof, in the present exemplary embodiment, the pressure loss when the air A1 passes through the flow path 62 can be greatly suppressed.

Moreover, in the present exemplary embodiment, in the flow path 62, the cross-sectional area of cross-section as viewed along the direction of flow of the air A1 at the outflow side flow path 62B on the outflow port 64 side is configured so as to be smaller than the cross-sectional area thereof at the inflow side flow path 62A on the inflow port 60 side.

This means that in the present exemplary embodiment, when there is the same flow volume of the air A1 on the inflow side flow path 62A side and on the outflow side flow path 62B side, the flow speed of the air A1 flowing in the outflow side flow path 62B becomes faster than the flow speed of the air A1 flowing in the inflow side flow path 62A.

This means that the angular velocity of turning of the air A1 due to the first deflection wall portions and the second deflection wall portions is larger on the outflow side flow path 62B side than on the inflow side flow path 62A side, enabling paint mist M having comparatively fine droplet size to be centrifugally separated from the air A1.

Note that in FIG. 5, the flow speed of the air A1 flowing in the flow path 62 is illustrated by dark/light shading in black, with a darker shading in black indicating greater flow speed.

Note that in the present exemplary embodiment, the flow line direction of the air A1 flowing into the inflow port 60, and the flow line direction of the air A1 flowing out from the outflow port 64, are set as the third direction. Namely, the flow line direction of the air A1 flowing into the inflow port 60, and the flow line direction of the air A1 flowing out from the outflow port 64, are substantially the same directions. Note that reference here to being substantially the same direction not only includes a state in which these directions are parallel, but also includes a range in which an angular difference between these directions is in a range of about from 0 degrees to 10 degrees.

Moreover, the inflow side flow path 62A and the outflow side flow path 62B are arranged in a row along the third direction, and are also arranged such that, in the second direction, the inflow port 60 is on the second direction one side and the outflow port 64 is on the second direction other side. The outlet on the second direction other side of the inflow side flow path 62A in the second direction and the inlet on the second direction one side of the outflow side flow path 62B in the second direction, are connected together by the connection flow path 62C extending in the second direction.

This means that in the present exemplary embodiment, a flow path length of the flow path 62 is secured, while also being able to suppress an increase in size of the filter units 34, and in particular an increase in size in the second direction.

Moreover, in the present exemplary embodiment, as illustrated in FIG. 6, the flow path 62 is provided so as to pass through the filter unit 34 in a specific through-pass direction, namely in the first direction. This means that, for example, in a state in which the upper lid 44 and the lower lid 46 have been moved by sliding, and a tool such as an ultrasound scraper S or the like has abutted against the wall portion 34I, the paint that has adhered to the wall portion 34I can be removed, together a portion of the sheet material 48, by moving this tool linearly in the first direction.

Moreover, in the present exemplary embodiment, the through-pass direction of the flow path 62 is set as the vertical direction, and the paint can be caused to fall off vertically downward under its own weight when removing paint from the flow path 62 with the tool.

In addition thereto, in the present exemplary embodiment, the sheet material 48 is interposed between the filter unit 34 and the upper lid 44, and between the filter unit 34 and the lower lid 46. This means that the filter unit 34 and the upper lid 44 can be suppressed from becoming fixed together by paint that has leaked from the flow path 62, and the filter unit 34 and the lower lid 46 can be suppressed from becoming fixed together thereby.

As described above, the paint mist removal device 10 according to the present exemplary embodiment enables reuse of the filter units 34 to which the paint has adhered.

### First Modified Example of Above Exemplary Embodiment

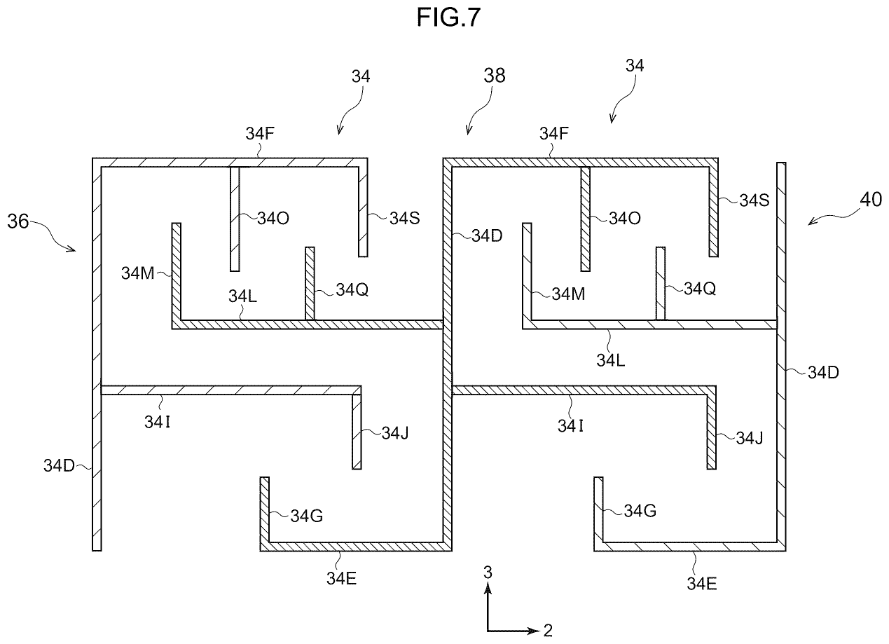

Description follows regarding a first modified example of the above exemplary embodiment, with reference to FIG. 7. The present modified example is configured basically the same as the above exemplary embodiment, except in that plural (two) of the filter units 34 linked in the second direction are integrated together, and also main components of such an assembly of the filter units 34 are three steel components, namely the assembly is configured by a first configuration component 36, a second configuration component 38, and a third configuration component 40.

More specifically, the first configuration component 36 includes the second direction one side wall portion 34D, the wall portion 34F, the wall portion 34I, the wall portion 34J, the wall portion 34O, and the wall portion 34S of the second direction one side filter unit 34.

The second configuration component 38 includes the wall portion 34D positioned at a boundary between the second direction one side filter unit 34 and the second direction other side filter unit 34, the wall portion 34E, the wall portion 34G, the wall portion 34L, the wall portion 34M, and the wall portion 34Q of the second direction one side filter unit 34, and also the wall portion 34F, the wall portion 34I, the wall portion 34J, the wall portion 34O, and the wall portion 34S of the second direction other side filter unit 34.

The third configuration component 40 includes the second direction other side wall portion 34D, the wall portion 34E, the wall portion 34G, the wall portion 34L, the wall portion 34M, and the wall portion 34Q of the second direction other side filter unit 34. Note that the wall portion 34D positioned at the boundary between the adjacent filter units 34 is a site common to these filter units 34.

The first configuration component 36, the second configuration component 38, and the third configuration component 40 configured as described above are configured such that relative movement between these components toward the first direction one side or toward the first direction other side is limited by the frame 42 configured by the respective angle materials.

Note that the present modified example is, as an example, configured without each of the extension wall portions, however a configuration with each of the extension wall portions may be adopted.

Moreover, each of the filter units 34 according to the present modified example may be configured by an extrusion molded material, or may be configured by angle material. When the filter units 34 are configured with angle material, plural of the filter units 34 can be configured by assembling pressed steel sheets or the like, and management of the materials for making the filter units 34 is easy compared to cases in which the filter units 34 are configured from extrusion molded material.

### Second Modified Example of Above Exemplary Embodiment

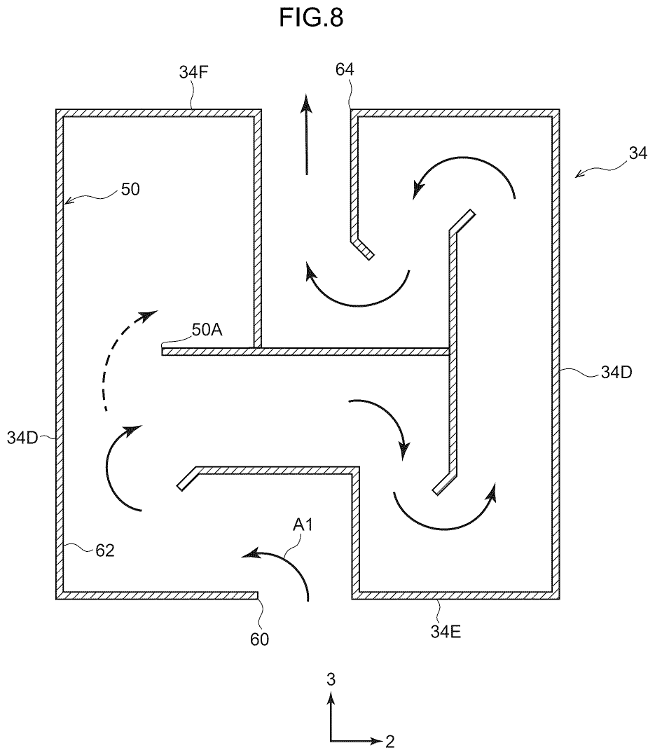

Description follows regarding a second modified example of the above exemplary embodiment, with reference to FIG. 8. In the present modified example, the filter unit 34 is configured including an inflow port 60, a flow path 62, and an outflow port 64, and is configured basically the same as the above exemplary embodiment. However, the present modified example differs from the above exemplary embodiment in the point that a chamber 50 is provided to the flow path 62.

More specifically, in the present modified example, the chamber 50 is positioned at an upstream side of the flow path 62 as a whole, and at a downstream side of a location on the flow path 62 where the direction of flow of the air A1 is changed. The chamber 50 is configured including some of the plural wall portions configuring the filter unit 34, and is configured in a state that communicates with the flow path 62 through an opening 50A, which is a single sole communication path with the flow path 62.

By adopting such a configuration, when a direction of the air A1 flowing in the flow path 62 is changed at the vicinity of the inlet to the chamber 50, paint mist M of comparatively large droplet size is centrifugally separated from the flow path 62 and is blown into and trapped in the chamber 50. Namely, the paint mist M is adhered to each of the wall portions configuring the chamber 50 and builds up as layers on the inside of the chamber 50. This means that the present modified example is able to contribute to the recovery of the paint mist M of comparatively large droplet size.

### Third Modified Example of Above Exemplary Embodiment

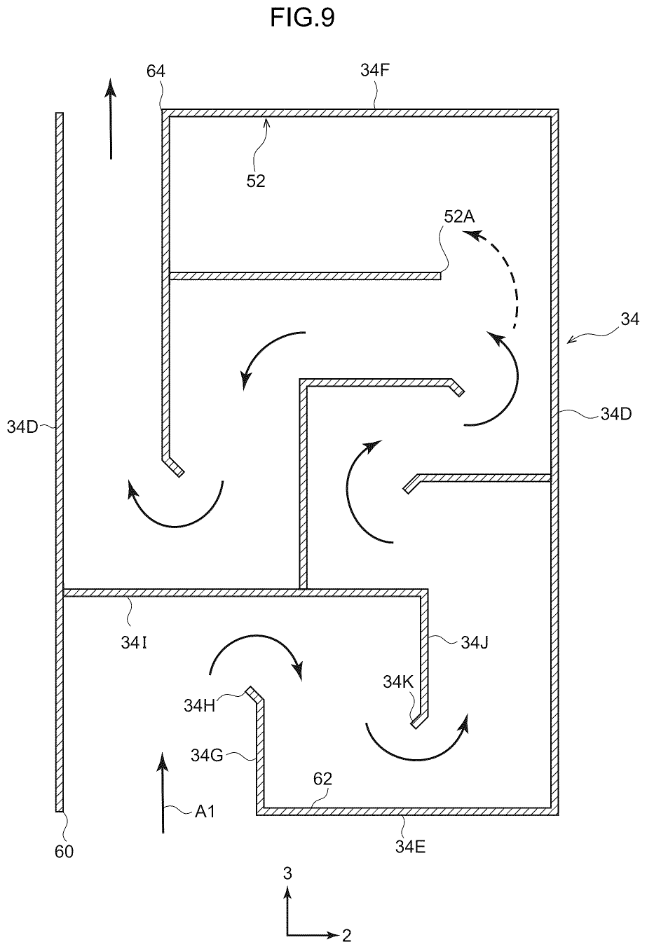

Description follows regarding a third modified example of the above exemplary embodiment, with reference to FIG. 9. In the present modified example, the filter unit 34 is configured including an inflow port 60, a flow path 62, and an outflow port 64, and is configured basically the same as the above exemplary embodiment. However, the present modified example differs from the above exemplary embodiment in the point that a chamber 52 is provided to the flow path 62.

More specifically, in the present modified example the chamber 52 is positioned at a downstream side of the flow path 62 as a whole, and at a downstream side of a location on the flow path 62 where the direction of flow of the air A1 is changed. The chamber 52 is configured including some of the plural wall portions configuring the filter unit 34, and is configured in a state that communicates with the flow path 62 through an opening 52A, which is a single sole communication path with the flow path 62.

By adopting such a configuration, when a direction of the air A1 flowing in the flow path 62 is changed at the vicinity of the inlet to the chamber 52, paint mist M of comparatively small droplet size is centrifugally separated from the flow path 62 and is blown into and trapped in the chamber 52. Namely, the paint mist M is adhered to each of the wall portions configuring the chamber 52 and builds up as layers on the inside of the chamber 52. This means that the present modified example is able to contribute to the recovery of the paint mist M of comparatively small droplet size.

### Fourth Modified Example of Above Exemplary Embodiment

Description follows regarding a fourth modified example of the above exemplary embodiment, with reference to FIG. 9. In the present modified example, the filter unit 34 is configured including an inflow port 60, a flow path 62, and an outflow port 64, and is configured basically the same as the above exemplary embodiment. However, the present modified example differs from the above exemplary embodiment in the point that the chamber 50 as described in the second modified example, and the chamber 52 as described in the third modified example, are each provided on the flow path 62.

By adopting such a configuration, a contribution can be made to the recovery of the paint mist M of comparatively large droplet size and to the recovery of the paint mist M of comparatively small droplet size.

### Supplementary Description of above Exemplary Embodiment

(1) Although in the above exemplary embodiment main portions of the filter unit 34 are configured from a metal, the material configuring the filter unit 34 is not limited thereto. For example, a configuration may be adopted in which plural of the filter units 34 are integrated together by configuring the filter units 34 from a resin.

(2) Moreover, although in the above exemplary embodiment the filter unit 34 was arranged such that the first direction was a vertical direction, the first direction of the filter unit 34 may be set as a horizontal direction according to the specification and the like of the paint mist removal device 10.

(3) In addition, although in the exemplary embodiment described above each of the wall portions configuring the flow path 62 of the filter unit 34 is configured so as to extend linearly, these wall portions may be configured curved according to the specification and the like of the paint mist removal device 10.

The following Supplements are also disclosed in related to the above exemplary embodiment.

### Supplement 1

A filter unit made of a metal or a resin, comprising:
an inflow port configured to allow inflow of air containing a paint mist;
a flow path through which the air that has flowed in from the inflow port flows, and that changes a direction of flow of the air at plural locations; and
an outflow port configured to allow outflow of the air that has passed through the flow path.

### Supplement 2

The filter unit of Supplement 1, wherein the flow path includes plural sets of a first deflection wall portion that receives a flow of the air and changes a direction of flow of the air, and a second deflection wall portion extended from the first deflection wall portion that receives a flow of the air along the first deflection wall portion and changes the direction of flow of the air, the plural sets being arranged in series along the flow of the air.

### Supplement 3

The filter unit of Supplement 2, wherein:
the second deflection wall portion is arranged at a location at which the flow path changes direction; and
the filter unit further comprises an extension wall provided at the second deflection wall portion at an opposite side from the first deflection wall portion, the extension wall portion extending toward a center line side of the flow path.

### Supplement 4

The filter unit of Supplement 2 or Supplement 3, wherein the flow path includes:
an inflow side flow path provided at a side of the inflow port; and
an outflow side flow path provided at a side of the outflow port and having a cross-sectional area of a cross-section as viewed along a direction of flow of the air that is smaller than a cross-sectional area of the inflow side flow path at the side of the inflow port.

### Supplement 5

The filter unit of Supplement 4,
wherein the inflow side flow path and the outflow side flow path each include a plurality of the sets arranged in series along the flow of the air.

### Supplement 6

The filter unit of Supplement 5,
wherein the flow path further includes a connection flow path that connects the inflow side flow path and the outflow side flow path;
wherein a flow line direction of the air flowing into the inflow port and a flow line direction of the air flowing out from the outflow port are substantially the same direction;
wherein the inflow side flow path, the connection flow path, and the outflow side flow path are arranged in a row along the flow line direction, and, in an orthogonal direction orthogonal to the flow line direction, the inflow port is arranged at one side in the orthogonal direction, and the outflow port is arranged at another side in the orthogonal direction; and
wherein, in the orthogonal direction, an outlet at the other side in the orthogonal direction of the inflow side flow path and an inlet at the one side in the orthogonal direction of the outflow side flow path are connected together by the connection flow path extending in the orthogonal direction.

### Supplement 7

A paint mist removal device comprising:
the filter unit of any one of Supplement 1 to Supplement 6, wherein the flow path is provided so as to pass through the filter unit in a specific pass-through direction; and
lids configured to close one side in the pass-through direction and another side in the pass-through direction of the flow path.

### Supplement 8

The paint mist removal device of Supplement 7, wherein the pass-through direction is a vertical direction.

### Supplement 9

The paint mist removal device of Supplement 7 or Supplement 8, further comprising a sheet member interposed between the filter unit and the lid.

### Supplement 10

The filter unit of any one of Supplement 1 to Supplement 6, further comprising a chamber that communicates with the flow path at a position on a downstream side of the flow path at a location at which the direction of flow of the air in the flow path is changed.

What is claimed is:

1. A filter unit made of a metal or a resin, comprising:
an inflow port configured to allow inflow of air containing a paint mist;
a flow path through which the air that has flowed in from the inflow port flows, and that changes a direction of flow of the air at a plurality of locations; and
an outflow port configured to allow outflow of the air that has passed through the flow path.

2. The filter unit according to claim 1,
wherein the flow path includes a plurality of sets of a first deflection wall portion that receives a flow of the air and changes a direction of flow of the air, and a second deflection wall portion extended from the first deflection wall portion that receives a flow of the air along the first deflection wall portion and changes the direction of flow of the air, the plurality of sets being arranged in series along the flow of the air.

3. The filter unit according to claim 2, wherein:
the second deflection wall portion is arranged at a location at which the flow path changes direction; and
the filter unit further comprises an extension wall portion provided at the second deflection wall portion at an opposite side from the first deflection wall portion, the extension wall portion extending toward a center line side of the flow path.

4. The filter unit according to claim 2,
wherein the flow path includes:
an inflow side flow path provided at a side of the inflow port; and
an outflow side flow path provided at a side of the outflow port and having a cross-sectional area of a cross-section as viewed along a direction of flow of the air that is smaller than a cross-sectional area of the inflow side flow path at the side of the inflow port.

5. The filter unit according to claim 4,
wherein the inflow side flow path and the outflow side flow path each include a plurality of the sets arranged in series along the flow of the air.

6. The filter unit according to claim 5,
wherein the flow path further includes a connection flow path that connects the inflow side flow path and the outflow side flow path;
wherein a flow line direction of the air flowing into the inflow port and a flow line direction of the air flowing out from the outflow port are substantially the same direction;
wherein the inflow side flow path, the connection flow path, and the outflow side flow path are arranged in a row along the flow line direction, and, in an orthogonal direction orthogonal to the flow line direction, the inflow port is arranged at one side in the orthogonal direction, and the outflow port is arranged at another side in the orthogonal direction; and
wherein, in the orthogonal direction, an outlet at the other side in the orthogonal direction of the inflow side flow path and an inlet at the one side in the orthogonal direction of the outflow side flow path are connected together by the connection flow path extending in the orthogonal direction.

7. A paint mist removal device comprising:
the filter unit according to claim 1, wherein the flow path is provided so as to pass through the filter unit in a specific pass-through direction; and
lids configured to close one side in the pass-through direction and another side in the pass-through direction of the flow path.

8. The paint mist removal device of claim 7,
wherein the pass-through direction is a vertical direction.

9. The paint mist removal device of claim 7, further comprising a sheet member interposed between the filter unit and the lid.

10. The filter unit according to claim 1, further comprising a chamber that communicates with the flow path at a position on a downstream side of the flow path at a location at which the direction of flow of the air in the flow path is changed.
